(19) United States
(12) Patent Application Publication
(10) Pub. No.: US 2008/0165252 A1
(43) Pub. Date: Jul. 10, 2008

(54) MONITORING SYSTEM

(76) Inventor: Junji Kamimura, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/959,524

(22) Filed: Dec. 19, 2007

(30) Foreign Application Priority Data
Dec. 25, 2006 (JP) 2006-346931

(51) Int. Cl. H04N 7/18

(52) U.S. Cl. 348/155

(57) ABSTRACT

A monitoring system is configured to include: a unit which performs image processing of picture images that are taken by one or more movable imaging devices, the one or more movable imaging devices being located around an object to be monitored; a unit which detects the occurrence of an abnormal state of the object to be monitored; and a unit which informs a specified security firm, device, person, or the like, of the occurrence of the abnormal state. In addition, the monitoring system further includes a unit which, in response to the number of imaging devices that are located around the object to be monitored, and a position of each of the imaging devices, changes a range within which the each of the imaging devices takes a picture image.

### CLAIM OF PRIORITY

The present application claims priority from Japanese application serial no. JP2006-346931, filed on Dec. 25, 2006, the content of which is hereby incorporated by reference into this application.

### BACKGROUND OF THE INVENTION

1. Field of the Invention

The present invention relates to a monitoring system.

2. Description of the Related Art

As the background art of this technical field, for example, JP-A-2003-304530 is disclosed. According to the abstract thereof, the object is, by monitoring a target in a desired direction around a vehicle, to prevent the damage such as a theft from occurring. As problem solving means, there are provided an in-vehicle device 2 including a camera 4 that is capable of controlling an image taking direction and the magnification, and a communication unit 7; and a terminal unit 3 including a display unit 33, an operation unit 31, and a terminal communication unit 32. A communication connection is made between the in-vehicle device 2 and the terminal unit 3, so that the in-vehicle device 2 transmits a camera picture image and image taking direction information to the terminal unit 3. Then, the terminal unit 3 displays the received camera picture image on the display unit 33. Next, on the basis of this displayed information, the terminal unit 3 inputs a camera image taking direction and magnification information, and then transmits them to the in-vehicle device 2.

### SUMMARY OF THE INVENTION

More and more monitoring cameras are placed at various locations such as houses, stores, ATMs of banks, and shopping streets. Therefore, the monitoring cameras become one of indispensable means for preventing or solving troubles. For example, if an apartment house is taken as an example, many fixed cameras are located; and image taking ranges of the cameras cover the entrance, the housetop, emergency staircases, and the like. In addition, in-vehicle cameras, which are used for private vehicles and taxis, are becoming widespread. The in-vehicle cameras produces the effect of reducing the number of traffic accidents that are caused by blind spots, and also produces the effect of investigating the cause of a traffic accident.

However, there are problems as described below. An increase in the number of fixed cameras located in an apartment house leads to an improvement in security. However, under the existing circumstances, although fixed cameras are located in common areas, not many fixed cameras are located in individual areas including the entrance of each room, and windows thereof; or even if many fixed cameras are located in such areas, the vast amount of capital expenditure is required, which results in a very high charge. In addition, many in-vehicle cameras do not operate when each vehicle equipped with each in-vehicle camera is kept in a parked state. Even if an in-vehicle camera operates, a monitoring range of the in-vehicle camera is limited to an area inside the vehicle or a narrow range around the vehicle.

Moreover, because fixed cameras and in-vehicle cameras are usually designed to display and store picture images that have been taken, the fixed cameras and the in-vehicle cameras are not capable of detecting an abnormal state from the picture images so as to inform a proper organization, device, or person of the abnormal state.

What is more, in large volume sellers and amusement centers, which attract unspecified number of private vehicles, each of which is equipped with an in-vehicle camera, the in-vehicle cameras are not effectively utilized while each vehicle equipped with each in-vehicle camera is kept in a parked state.

Furthermore, because the power of an in-vehicle camera is supplied from a battery located in a movable body such as a private vehicle, if the in-vehicle camera continuously monitors an area around the movable body such as a private vehicle, the amount of electricity accumulated in the battery decreases, which exerts an influence upon driving of the movable body itself.

To be more specific, there are the following objects:

1. reducing the capital expenditure that is required to improve the security;
2. providing a function of detecting an abnormal state from taken picture images so as to inform a proper organization, device, or person of the abnormal state;
3. effectively utilizing imaging devices that are located within a certain range; and
4. supplying the power used for a movable imaging device from means that is different from a battery used to drive a movable body equipped with the movable imaging device.

As one example, at least one of the above-described objects can be achieved by: while a vehicle equipped with an in-vehicle camera is parking in a parking space of an apartment house, taking a picture image of a room that is a target to be monitored; and at the time of the occurrence of an abnormal state, informing a specified security firm, device, or person of the occurrence of the abnormal state.

According to the present invention, it is possible to achieve a functional improvement of a monitoring system.

Incidentally, objects, configurations, and effects, other than those described above, will be described in embodiments of the present invention.

### BRIEF DESCRIPTION OF THE DRAWINGS

These and other features, objects and advantages of the present invention will become more apparent from the following description when taken in conjunction with the accompanying drawings wherein:

FIG. 1 is a diagram illustrating a first embodiment;

FIG. 2 is a diagram illustrating effects of the first embodiment;

FIG. 3 is a diagram illustrating effects of a second embodiment;

FIG. 4 is a diagram illustrating effects of the second embodiment;

FIG. 5 is a diagram illustrating effects of a third embodiment;

FIG. 6 is a diagram illustrating effects of a fourth embodiment;

FIG. 7 is a diagram illustrating the fourth embodiment;

FIG. 8 is a diagram illustrating a fifth embodiment;

FIG. 9 is a diagram illustrating effects of the fifth embodiment;

FIG. 10 is a diagram illustrating a sixth embodiment;

FIG. 11 is a diagram illustrating effects of the sixth embodiment;

FIG. 12 is a diagram illustrating a seventh embodiment; and

FIG. 13 is a diagram illustrating an eighth embodiment.

### DETAILED DESCRIPTION OF THE EMBODIMENT

Embodiments of the present invention will be described with reference to drawings as below. Incidentally, the embodiments of the present invention will be outlined as below.

First of all, a monitoring system according to this embodiment (hereinafter also referred to as a “monitoring network”) is configured to includes: a unit which performs image processing of picture images that are taken by one or more imaging devices, the one or more imaging devices being located around an object to be monitored; a unit which detects the occurrence of an abnormal state of the object to be monitored; and a unit which informs a specified security firm, device, or person of the occurrence of the abnormal state. It is possible to detect the abnormal state from the picture image taken by this configuration, and to inform a proper organization, device, or person of the abnormal state.

In addition, the monitoring system according to this embodiment is configured to further include a unit which, in response to a position of each of the imaging devices that are located around the object to be monitored, changes a range within which the each of the imaging devices takes a picture image. This configuration makes it possible to reduce the capital expenditure, or to effectively utilize the imaging devices that are located within the range.

In addition, the monitoring system according to this embodiment is configured to further include: a unit which detects the number of imaging devices that are located around the object to be monitored; and a unit which, in response to the number of imaging devices that are located around the object to be monitored, changes a range within which the each of the imaging devices takes a picture image. This configuration makes it possible to reduce the capital expenditure, or to effectively utilize the imaging devices that are located within the range.

In addition, the monitoring system according to this embodiment is configured to further include a unit which transmits information used for, in a place that attracts unspecified number of movable bodies, each of which is equipped with the imaging device, guiding each of the movable bodies to a position at which an image of the whole object to be monitored can be most effectively taken. This configuration makes it possible to effectively utilize the imaging devices that are located within the range.

In addition, the monitoring system according to this embodiment is configured to further include a unit which transmits information used for, in a place that attracts unspecified number of movable bodies, each of which is equipped with the imaging devices, controlling image taking of an area around or inside another movable body that exists on the front or back side, or on the right or left side, of the movable body. This configuration makes it possible to effectively utilize the imaging devices that are located within the range.

In addition, the monitoring system according to this embodiment is configured to further include: a unit which tracks a movable body existing in a received picture image; and a unit which, on the basis of the information received from the unit, changes an image taking range of each of the plurality of existing imaging devices so that an image of the movable body is always taken. This configuration makes it possible to effectively utilize the imaging devices that are located within the range.

In addition, the monitoring system according to this embodiment is configured to further include a unit which, when the output of the unit which detects the occurrence of the abnormal state from the picture image is a signal that indicates an abnormal state, transmits an instruction to take an image of an area, in which the abnormal state has occurred, by use of all of the imaging devices existing around the position. This configuration makes it possible to effectively utilize the imaging devices that are located within the range.

In addition, the monitoring system according to this embodiment is configured to supply the power supply, which is used to drive the imaging devices, from the dedicated power supply. This configuration makes it possible to effectively utilize the imaging devices that are located within the range.

Moreover, the monitoring system according to this embodiment is configured to further include a unit that operates only when the movable body equipped with the imaging device is kept in a parked state. This configuration makes it possible to effectively utilize the imaging devices that are located within the range.

According to this embodiment, one or more imaging devices, each of which can be moved to an arbitrary position around an object to be monitored, are connected to one another through a network. Picture images taken by the one or more imaging devices are subjected to image processing to detect an abnormal state that has occurred in the object to be monitored. As a result, it is possible to inform a specified security firm, device, or person of the occurrence of the abnormal state. In addition, if an imaging device, which can be moved to an arbitrary position, is an in-vehicle camera, the imaging device is used as a monitoring network camera. Therefore, the imaging device can be used both for the prevention of a traffic accident and for monitoring a house. As a result, it is possible to reduce the capital expenditure required to improve the security.

### First Embodiment

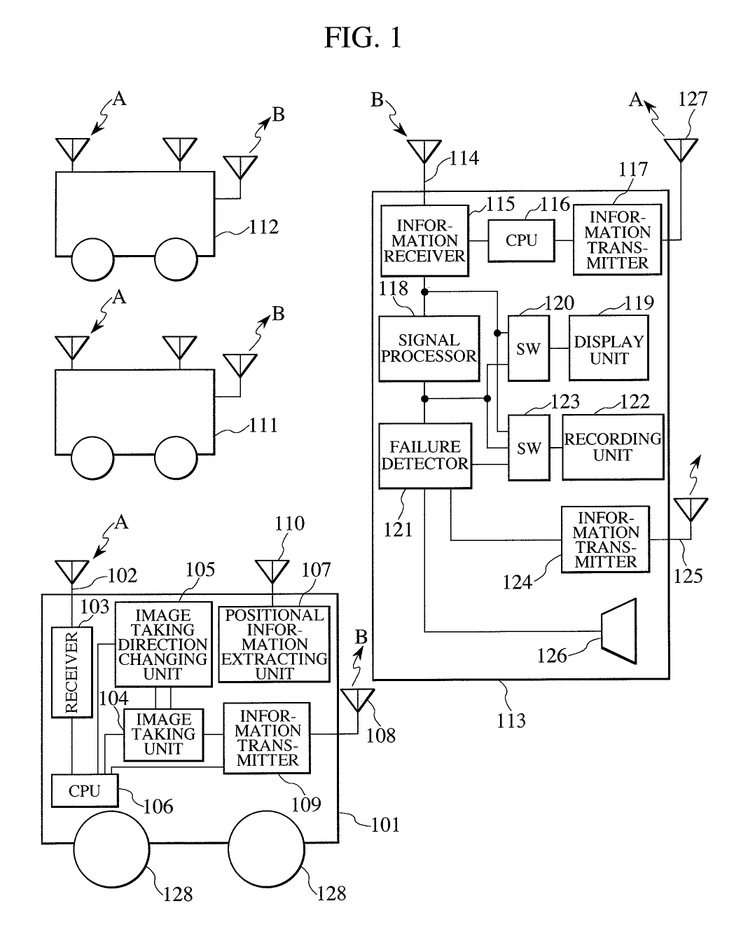

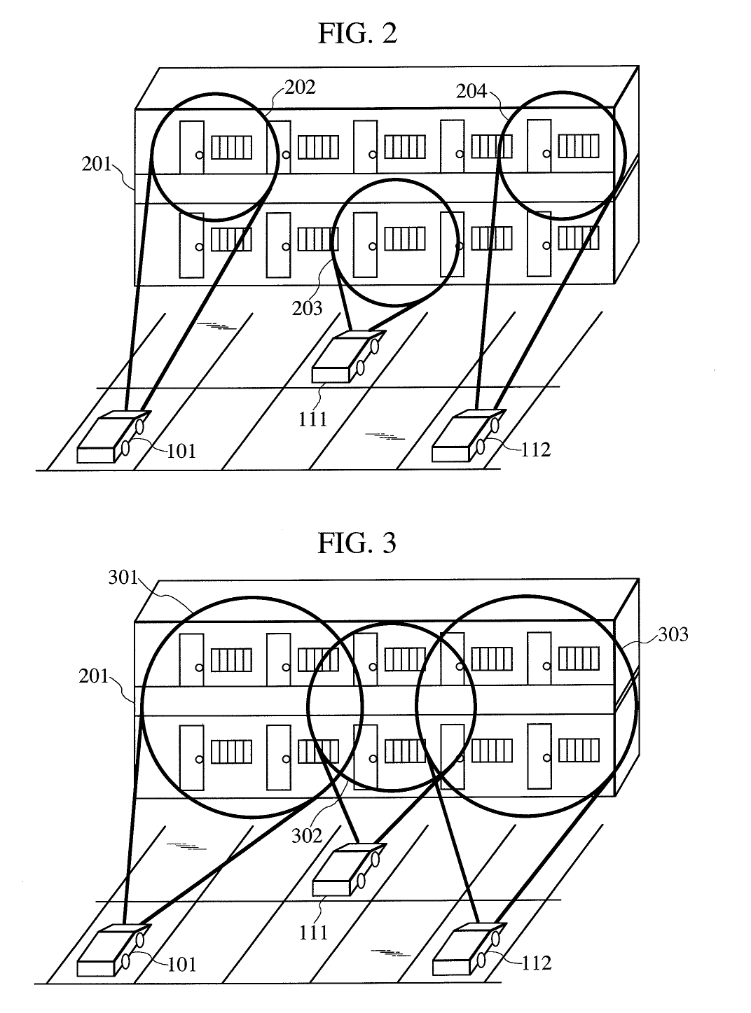

A first embodiment will be described with reference to FIGS. 1, 2. FIG. 1 is a diagram illustrating a monitoring network according to the present invention. FIG. 2 is a diagram illustrating monitoring ranges according to this embodiment.

In FIG. 1, reference numerals 101, 111, 112 denote movable imaging devices. Each of the imaging devices includes: antennas 102, 108, 110; a receiver 103 for demodulating a radio wave received by the antenna 102 so that required information is extracted; an image taking unit 104 for taking a picture image; an image taking direction changing unit 105 for changing an image taking direction of the image taking unit 104 up and down and right and left; a CPU 106 that outputs an operation instruction to the image taking unit 104 and the image taking direction changing unit 105 on the basis of the information extracted by the receiver 103; a positional information extracting unit 107 for demodulating a radio wave received by the antenna 110 so that positional information is extracted; and an information transmitter 109 for performing modulation on the basis of a specified modulation method so that the picture image taken by the image taking unit 104, and the positional information extracted by the positional information extracting unit 107, are transmitted to the outside.

A control device 113 receives picture images from the imaging devices 101, 111, 112, and then performs display processing, recording processing, and signal processing. In addition, the control device 113 transmits operating conditions to the imaging devices 101, 111, 112.

The control device 113 includes: an information receiver 115 for demodulating a radio wave transmitted from each of the imaging devices 101, 111, 112, and for separating the demodulated signal into a picture signal and positional information before outputting them, the radio wave being received by the antenna 114; a CPU 116 for, on the basis of the positional information received from the information receiver 115, calculating operating conditions that are most suitable for the imaging devices 101, 111, 112; and an information transmitter 117 for performing modulation on the basis of a specified modulation method so that the result of the calculation by the CPU 116 is transmitted to the imaging devices 101, 111, 112.

In addition, the control device 113 further includes: a signal processor 118 for performing specified signal processing of the picture signal received from the information receiver 115; a display unit 119 for displaying a picture image; a selector 120 for selecting a picture image to be supply to the display unit; a failure detector 121 for detecting an abnormal state from the output of the signal processor 118 according to specified conditions; and a recording unit 122 for recording information.

Moreover, the control device 113 further includes: a selector 123 for selecting information to be supplied to the recording unit 122; an information transmitter 124 for, when the output of the failure detector 121 indicates an abnormal state, performing modulation on the basis of a specified modulation method so that abnormal-state information is transmitted to the outside proper organization, or device; antennas 114, 125, 127; a speaker 126 for, when the output of the failure detector 121 indicates an abnormal state, informing surrounding people of the abnormal state; and transportation unit 128 such as tires.

The connections will be described as below. In the movable imaging device 101, the antenna 102 is connected to the receiver 103; the output of the receiver 103 is connected to the input of the CPU 106; three outputs of the CPU 106 are connected to the input of the image taking direction changing unit 105, that of the image taking unit 104, and that of the information transmitter respectively; a connection between the image taking direction changing unit 105 and the image taking unit 104 is made through a rotary table, top and bottom pan heads, or the like; the antenna 110 is connected to the positional information extracting unit 107; the output of the positional information extracting unit 107, and that of the image taking unit 104, are connected to the inputs of the information transmitter 109 respectively; and the output of the information transmitter 109 is connected to the antenna 108. The connections inside each of the movable imaging devices 111, 112 are the same as those inside the movable imaging device 101.

In addition, in the control device 113, the antenna 114 is connected to the input of the information receiver 115; one of the two outputs of the information receiver 115 is connected to the input of the CPU 116, whereas the other is connected to the input of the signal processor 118, and to the inputs of the selectors 120, 123; the output of the CPU 116 is connected to the input of the information transmitter 117; the output of the information transmitter 117 is connected to the antenna 127; the output of the signal processor 118 is connected to the input of the failure detector 121, and to the inputs of the selectors 120, 123; three outputs of the failure detector 121 are connected to the input of the selector 123, that of the information transmitter 124, and that of the speaker 126 respectively; the output of the selector 120 is connected to the input of the display unit 119; and the output of the information transmitter 124 is connected to the antenna 125. In addition, each of the movable imaging devices 101, 111, 112 communicates with the control device 113 by use of radio waves A, B shown in the figure.

In FIG. 2, reference numeral 201 denotes an object to be monitored; reference numeral 202 denotes an image taking range of the movable imaging device 101; reference numeral 203 denotes an image taking range of the movable imaging device 111; and reference numeral 204 is an image taking range of the movable imaging device 112.

The operation will be described as below. Each of the movable imaging devices 101, 111, 112 receives positional information that indicates a parking position of a vehicle equipped with the movable imaging device in question with respect to an object to be monitored. An identifying signal that is provided on a parking position basis, or positional information based on the global positioning system (hereinafter referred to as “GPS”), may also be used as the positional information. Next, the CPU 106 outputs a modulation instruction to the information transmitter 109 according to modulation method information that is obtained as a result of the receipt of information from the control device 113. The information transmitter 109 transmits positional information to the control device 113 according to the command of the CPU 106. On the receipt of the transmitted information, from the positional information of each movable imaging device, which is output by the information receiver 115, the CPU 116 included in the control device 113 calculates image taking conditions including an image taking direction, and the exposure control, which are determined by a specified method, for each of the movable imaging devices 101, 111, 112. Then, the CPU 116 transmits the calculated image taking conditions through the information transmitter 117. On the basis of the received image taking conditions, the CPU 106 included in each of the movable imaging devices 101, 111, 112 issues an operating condition changing instruction to the image taking direction changing unit 105 and the image taking unit 104, and also issues an instruction to transmit a picture image, which has been taken by the image taking unit 104, to the control device 113 through the information transmitter 109. Intervals at which a picture image taken at this point of time is transmitted are based on the operating conditions of the control device 113. The CPU included in the control device 113 issues an instruction to transmit, to the movable imaging devices 101, 111, 112, the image taking conditions including an image taking direction and the exposure control, which have been subjected to fine adjustment on the basis of the received picture image, so that a most suitable image taking environment is provided. After that, the information receiver 115 included in the control device 113 outputs a picture signal into which picture images received from the movable imaging devices 101, 111, 112 are mixed on a unit time basis, or by a method in which one screen is sectioned into portions, the number of which is equivalent to the number of received picture images (in this case, one screen is sectioned into three). For example, every time the information receiver 115 outputs a picture image, the signal processor 118 performs signal processing to extract difference information. On the basis of the result of the signal processing, for example, when difference information is detected at the same position of the picture image for the specified length of time or more, the failure detector 121 judges that an abnormal state has occurred. Then, the failure detector 121 transmits abnormal-state information to the outside through the information transmitter 124, and uses the speaker 126 to inform surrounding people that the abnormal state has occurred.

Next, a control method of the CPU 116 will be described in detail. The information receiver 115 outputs, to the CPU 116, a parking position of each vehicle that is equipped with each of the movable imaging devices 101, 111, 112. From the parking position, the CPU 116 reads out data of image taking ranges that are registered on a parking position basis beforehand, and thereby determines image taking ranges 202, 303, 304. Therefore, for example, if an owner of the movable imaging device 101 registers the owner's residential part of the object to be monitored 201, it is possible to monitor the residential part by use of the in-vehicle camera located in the owner's vehicle.

The above-described operation makes it possible to extract an abnormal state from picture images taken by the movable imaging devices 101, 111, 112, and to inform a proper organization, device, or person of the abnormal state. As a result, because the in-vehicle camera which is primarily used for another purpose can be used for, for example, monitoring of collective housing, it is possible to reduce the capital expenditure. In addition, if each of the image taking ranges 202, 203, 204 is set at a wider value, not only the owner's residential part, but also the residential part of an owner of a vehicle that is not equipped with an in-vehicle camera, can be thoroughly monitored.

The above-described operation of the signal processor 118 and that of the failure detector 121 are simplified for clarification of the explanation. However, it is needless to say that in order to prevent a proper organization, device, or person from being informed of an abnormal state by mistake, more complicated processing based on various kinds of conditions may also be performed, or that the number of movable imaging devices is not limited to that described in the above example. In addition, it is needless to say that although the in-vehicle cameras are used as the movable imaging devices here, it is not necessary to limit the movable imaging devices to the in-vehicle cameras, and accordingly, for example, movable image taking robots may also be adopted in like manner.

### Second Embodiment

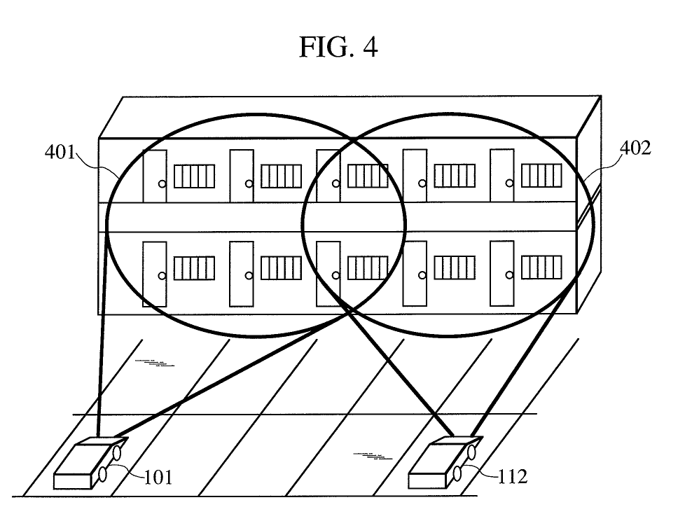

A second embodiment will be described with reference to FIGS. 3, 4. The control method of the CPU 116 according to the embodiment shown in FIG. 1 is changed in the second embodiment.

In FIGS. 3, 4, reference numerals 301, 401 denote an image taking range of the movable imaging device 101 in this embodiment; reference numeral 302 denotes an image taking range of the movable imaging device 111 in this embodiment; and reference numerals 303, 402 denote an image taking range of the movable imaging device 112 in this embodiment.

The operation will be described as below. On the basis of information received from the information receiver 115, the CPU 116 identifies the number of movable imaging devices that currently exist around the object to be monitored 201, and a position of each of the movable imaging devices. Then, on the basis of the distance relationship between the object to be monitored 201 and each of the movable imaging devices, the CPU 116 calculates an image taking range of each of the movable imaging devices according to a specific rule, the image taking range covering part of the object to be monitored 201. For example, because each of the movable imaging devices 101, 112 shown in FIG. 3 is sufficiently spaced away from the object to be monitored 201, it is judges that the each of the movable imaging devices 101, 112 can take a picture image over a wide range of the object to be monitored 201. Accordingly, an image taking range is so calculated that the image taking range covers two doors in each of the first and second floors of the object to be monitored 201. On the other hand, because the movable imaging device 111 shown in FIG. 3 is not sufficiently spaced away from the object to be monitored 201, it is judged that the movable imaging device 111 can take a picture image only over a narrow range of the object to be monitored 201. Accordingly, an image taking range is so calculated that the image taking range covers one door in each of the first and second floors of the object to be monitored 201. Other operational features are the same as those described in the embodiment shown in FIG. 1.

Next, when the movable imaging device 111 moves in this state, with the result that the movable imaging device 111 leaves an area in which it is possible to monitor the object to be monitored 201, the CPU 116 receives information from the information receiver 115, and thereby judges that the movable imaging device 111 does not exist around the object to be monitored 201. Then, on the basis of the distance relationship between the object to be monitored 201 and each of the remaining movable imaging devices, the CPU 116 calculates an image taking range of the each of the remaining movable imaging devices according to the specific rule, the image taking range covering part of the object to be monitored 201. For example, because each of the movable imaging devices 101, 112 shown in FIG. 4 is sufficiently spaced away from the object to be monitored 201, it is judges that the each of the movable imaging devices 101, 112 can take a picture image over a wide range of the object to be monitored 201. Accordingly, an image taking range is so calculated that the image taking range covers three doors in each of the first and second floors of the object to be monitored 201. Other operational features are the same as those described in the embodiment shown in FIG. 1.

As a result of the above-described operation, the number of movable imaging devices that exist around the object to be monitored 201, and a position of each of the movable imaging devices, are identified, and thereby an image taking range of each of the movable imaging devices is calculated. Therefore, even if the number of movable imaging devices or the position of each of the movable imaging devices changes, it is possible to take picture images under the most suitable image taking conditions so as to monitor the object to be monitored 201. This makes it possible to reduce the capital expenditure for monitoring, or to effectively utilize the imaging devices that are located within the range.

### Third Embodiment

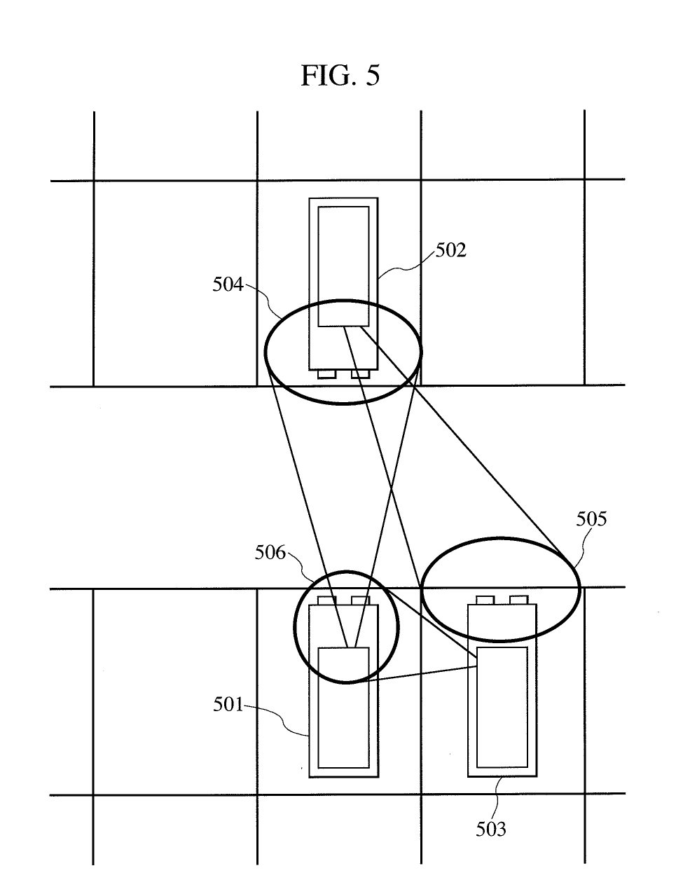

A third embodiment will be described with reference to FIG. 5. FIG. 5 is a diagram illustrating a control method of the CPU 116 that is changed from the control method of the CPU 116 according to the embodiment shown in FIG. 1. The control method in this embodiment is used to monitor a parking space of a large volume seller, a pachinko parlor, or the like, in which unspecified number of movable imaging devices gather. Reference numerals 501, 502, 503 denote movable imaging devices; reference numeral 504 denotes an image taking range of the movable imaging device 501; reference numeral 505 denotes an image taking range of the movable imaging device 502; and reference numeral 506 denotes an image taking range of the movable imaging device 503.

The operation will be described as below. On the basis of information received from the information receiver 115, the CPU 116 identifies the number of movable imaging devices, each of which currently exists in the parking space, and a position of each of the movable imaging devices. Then, on the basis of the distance relationship among the movable imaging devices, the CPU 116 calculates an image taking range of the each of the movable imaging devices according to the specific rule, the image taking range covering part of the each of the movable imaging devices. For example, as shown in FIG. 5 that illustrates the movable imaging devices 501, 502, 503, it is judged that the distance between the movable imaging devices 501, 502, and the distance between the movable imaging devices 502, 503, are long, whereas the distance between the movable imaging devices 501, 503 is short. Therefore, image taking ranges are so calculated that the image taking ranges 504, 505 becomes wide, whereas the image taking range 506 becomes narrow. As a result of the above-described operation, if the distance between the movable imaging devices is long enough to take a picture image over a wide range, it is possible to take a picture image of the whole object to be monitored. On the other hand, if the distance between the movable imaging devices is so short that a picture image can be taken only over a narrow range, it is possible to take a picture image focusing on a portion whose importance is high, for example, the front side of the object to be monitored, and a driver's seat.

As a result of the above-described operation, the number of movable imaging devices, each of which currently exists in the parking space, and a position of each of the movable imaging devices, are identified so as to calculate an image taking range of each of the movable imaging devices. Therefore, it is possible to take picture images under the most suitable image taking conditions. This makes it possible to reduce the capital expenditure for monitoring, or to effectively utilize the imaging devices located within the range.

As a result, it is possible to monitor an accident that is likely to occur in a parking space, such as a hit-and-run accident causing property damage. In addition to it, it is possible to detect an abnormal state from taken images. This makes it possible to extract a change in state inside each vehicle equipped with each movable imaging device so that a baby, or an animal, which is left inside the vehicle, is detected, and to inform a proper organization, device, or person of the detection. Moreover, it is also possible to solve a problem of forgetting about turning off headlights, or an interior light, in the same manner.

### Fourth Embodiment

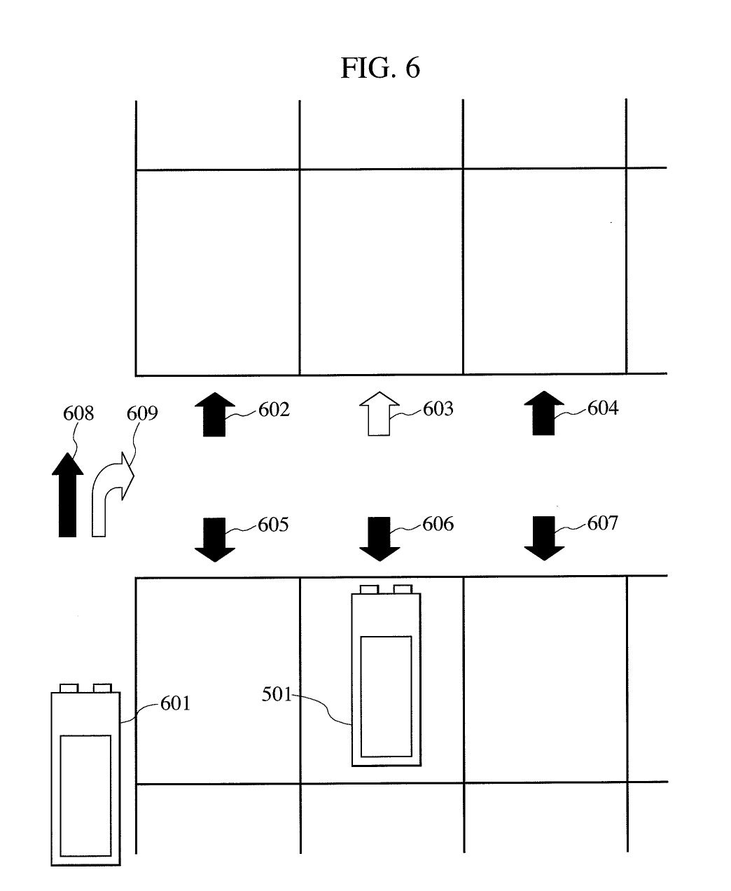

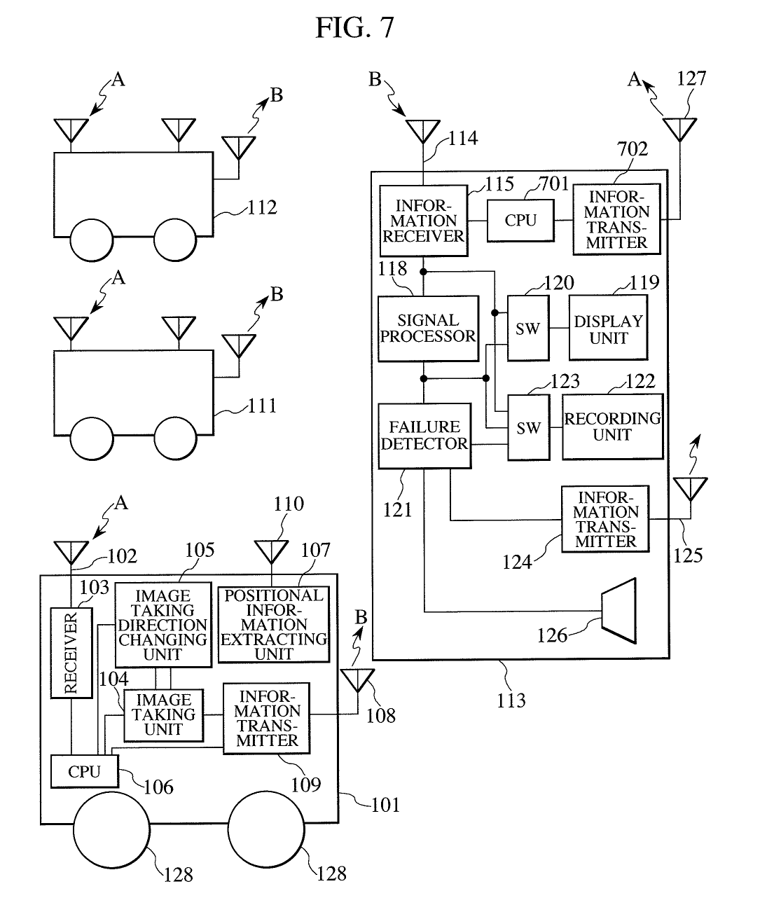

A fourth embodiment will be described with reference to FIGS. 6, 7. FIG. 6 is a diagram illustrating a control method of the CPU 116 that is changed from the control method of the CPU 116 according to the embodiment shown in FIG. 1. The control method in this embodiment is used to monitor a parking space of a large volume seller, a pachinko parlor, or the like, in which unspecified number of movable imaging devices gather. In addition, in FIG. 6, the information transmitter 117 also transmits information to other kinds of devices. FIG. 7 is a diagram illustrating an example in which the CPU 116 and the information transmitter 117 according to the embodiment shown in FIG. 1 are replaced with a CPU 701 and an information transmitter 702 respectively according to this embodiment. Reference numeral 601 denotes a movable imaging device that is currently moving; and reference numerals 602 through 609 denote guide lights, each of which can be switched on/off according to an instruction transmitted from the information transmitter 702 shown in FIG. 7. Reference numeral 701 denotes a CPU that has not only the same functions as those of the CPU 116 shown in FIG. 1, but also a function of calculating a position at which a movable imaging device is required to perform more efficient monitoring; and reference numeral 702 denotes an information transmitter that has not only the same functions as those of the information transmitter 117 shown in FIG. 1, but also an information transmission function of transmitting information to the guide lights 602 through 609.

The operation will be described as below. On the basis of information received from the information receiver 701, the CPU 116 identifies the number of movable imaging devices, each of which currently exists in the parking space, and a position of each of the movable imaging devices. Then, on the basis of the distance relationship among the movable imaging devices, the CPU 116 calculates an image taking range of the each of the movable imaging devices according to the specific rule, the image taking range covering part of the each of the movable imaging devices. The CPU 701 also calculates a position at which a movable imaging device is required to perform more efficient monitoring, and also calculates conditions such as the height of a position at which an image taking unit of a movable imaging device is mounted.

Next, on the basis of information about the height of a position at which the image taking unit is mounted, the information being transmitted from the moving movable imaging device 601 that is entering a parking space, the CPU 701 searches for a parking position of the movable imaging device 601 at which monitoring can be most efficiently performed, and then individually transmits a switch on/off instruction to the guide light 602 through 609 through the information transmitter 702 so that the movable imaging device 601 is guided to the position.

For example, as shown in FIG. 6, when only one vehicle equipped with the movable imaging device 501 parks, the CPU 701 judges that if another imaging device is located at a position at which the another imaging device faces the movable imaging device 501, the efficiency of monitoring increases. In such a situation, if the moving movable imaging device 601 which is newly entering satisfies the image taking conditions, the guide lights 603, 609 light up so that the movable imaging device 601 is guided to a position at which the movable imaging device 601 faces the movable imaging device 501.

As a result of the above-described operation, the number of movable imaging devices, each of which currently exists in the parking space, and a position of each of the movable imaging devices, are identified so as to calculate an image taking range of each of the movable imaging devices. Therefore, it is possible to take picture images under the most suitable image taking conditions. This makes it possible to effectively utilize the imaging devices located within the range.

As a result, it is possible to monitor an accident that is likely to occur in a parking space, such as a hit-and-run accident causing property damage. In addition to it, it is possible to detect an abnormal state from taken images. This makes it possible to extract a change in state inside each vehicle equipped with each movable imaging device so that a baby, or an animal, which is left inside the vehicle, is detected, and to inform a proper organization, device, or person of the detection. Moreover, it is also possible to solve a problem of forgetting about turning off headlights, or an interior light, in the same manner.

### Fifth Embodiment

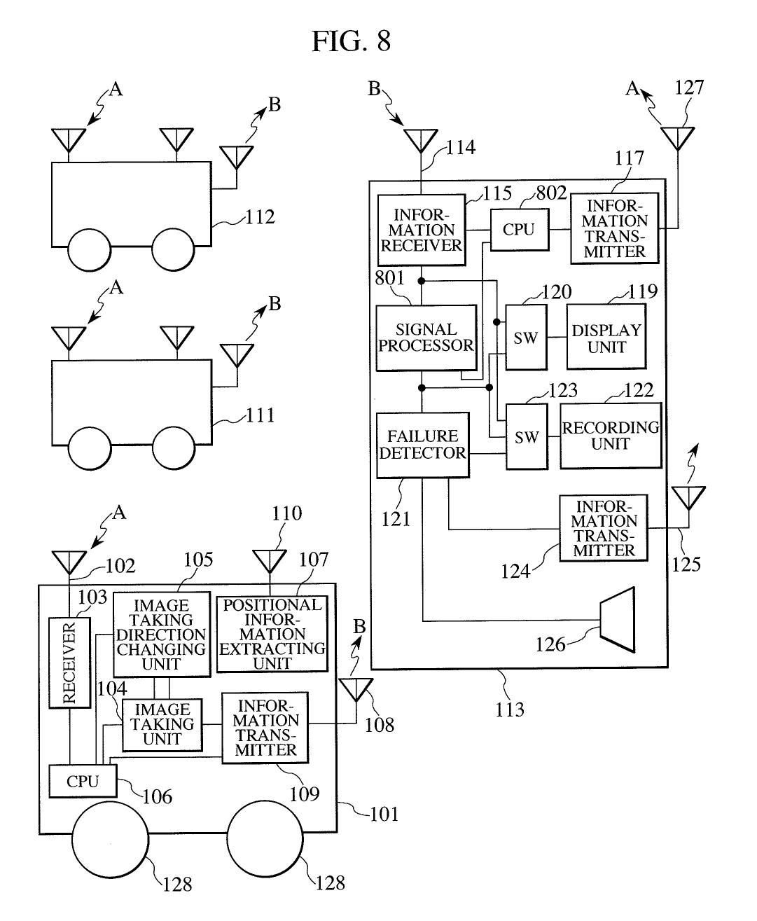

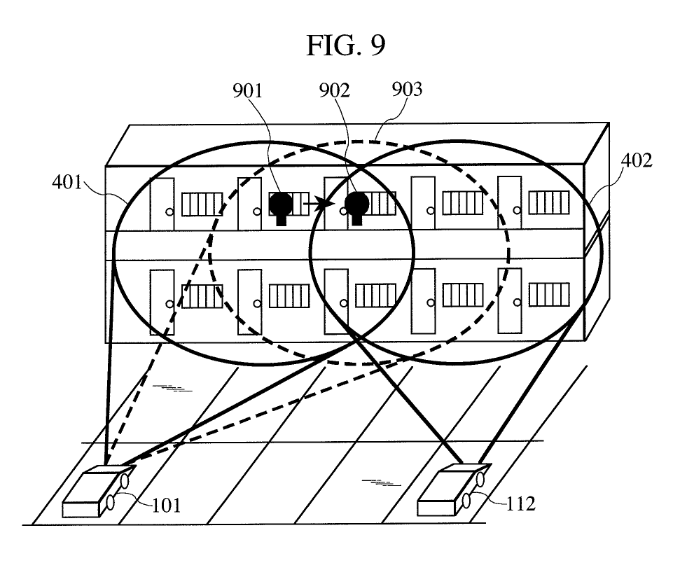

A fifth embodiment will be described with reference to FIGS. 8, 9. FIG. 8 is a diagram illustrating an example in which the signal processor 118 according to the embodiment shown in FIG. 1 further includes signal processing of extracting, from the difference between images taken at different fields of view, the distance by which a moving object has moved in a taken image, and in which the CPU 116 further includes a function of determining an image taking range of each movable imaging device also with reference to the new output of the signal processor according to this embodiment. FIG. 9 is a chart illustrating a change in image taking range of each movable imaging device when an moving object exists in an object to be monitored.

In FIG. 8, reference numeral 801 denotes a signal processor that performs not only the same processing as that of the signal processor 118 shown in FIG. 1, but also the processing of extracting, from the difference between images taken at different fields of view, the distance by which a moving object has moved in a taken image; and reference numeral 802 denotes a CPU that has not only the same functions as those of the CPU 116, but also a function of determining an image taking range of each movable imaging device also with reference to the new output of the signal processor 801. Next, the connections will be described. The signal processor 118 and the CPU 116 according to the embodiment shown in FIG. 1 are replaced with the signal processor 801 and the CPU 802 respectively. The new output of the signal processor 801 is connected to the new input of the CPU 802. The other connections are the same as those described in the embodiment shown in FIG. 1. In FIG. 9, reference numeral 901 denotes an object before it moves; reference numeral 902 denotes the object after it has moved; and reference numeral 903 denotes an image taking range of the movable imaging device 101 after the change.

The operation will be described as below. If the object 901 before the move exists in a taken image that has been transmitted from each movable imaging device, the object 901 having been judged to be an abnormal movable body by a specified extraction method, the signal processor 801 extracts the moving distance between the object 901 and the object 902 after the move, for example, from the difference between images taken at different fields of view, and then transmits the moving distance to the CPU 802. On the basis of the moving distance, the CPU 802 changes the image taking range 401 to the image taking range 903, and then transmits an image taking instruction to the movable imaging device 101 through the information transmitter 117. Next, before the object 902 after the move goes out of the image taking range of the movable imaging device 101, the CPU 802 instructs not the movable imaging device 101 but the movable imaging device 112 to change the image taking range.

As a result of the above-described operation, it is possible to continuously take images of a state in which an abnormal movable body is moving, and to expect an improvement in security.

### Sixth Embodiment

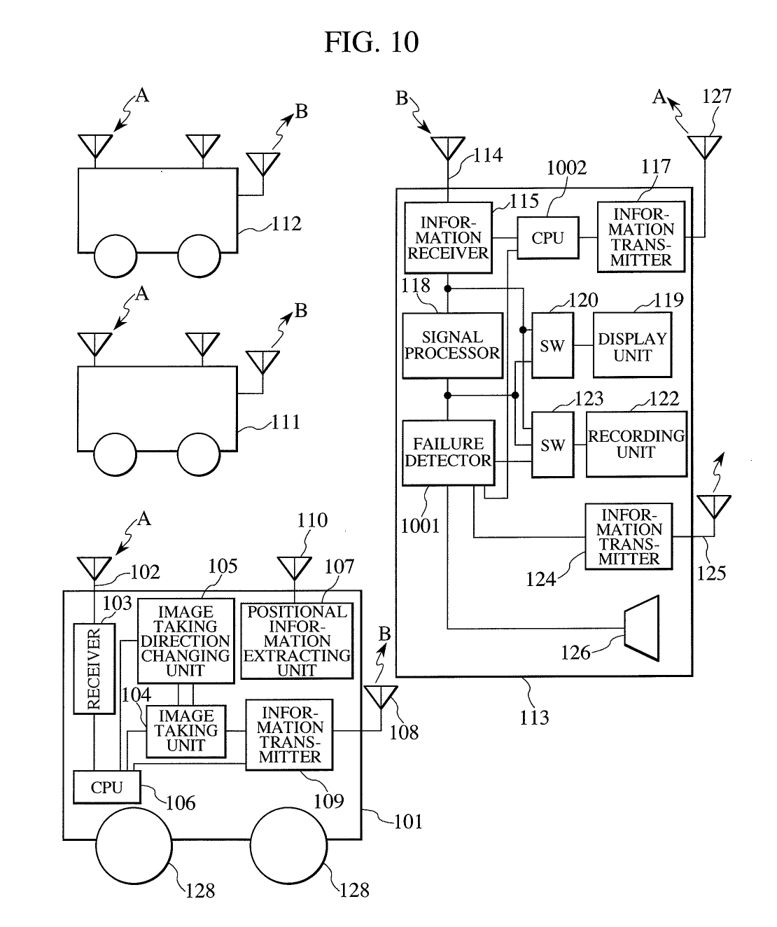

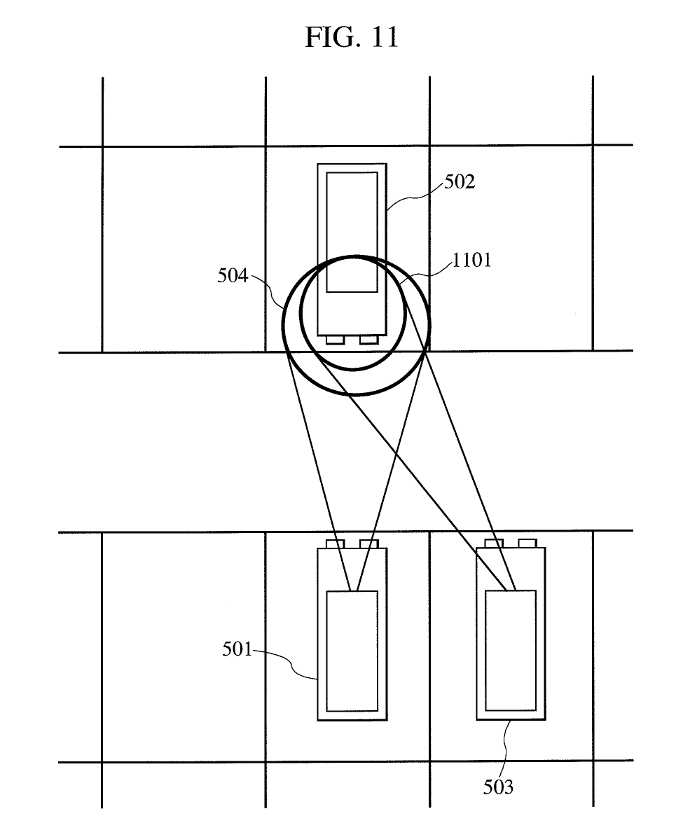

A sixth embodiment will be described with reference to FIGS. 5, 10, 11. FIG. 10 is a diagram illustrating an example in which the failure detector 121 and the CPU 116 according to the embodiment shown in FIG. 1 are replaced with a failure detector 1001 and a CPU 1102 respectively. The failure detector 1001 has not only the same functions as those of the failure detector 121, but also a function of, when an abnormal state occurs, outputting a signal also to the CPU to notify the CPU of the abnormal state. The CPU 1102 has not only the same functions as those of the CPU 116, but also a function of referring to the signal when an image taking range is calculated. Next, the connections will be described. The new output of the failure detector 1001 is connected to the new input of the CPU 1102. The other connections are the same as those described in the embodiment shown in FIG. 1. FIG. 11 is a diagram illustrating how an image taking range of the movable imaging device 503 changes according to this embodiment. Reference numeral 1101 denotes an image taking range of the movable imaging device 503 after the change.

The operation will be described as below. If image taking ranges of the movable imaging devices correspond to the image taking ranges 504, 505, from a picture image taken by the movable imaging device 501, the failure detector 1001 judges according to a specified rule that an abnormal state has occurred. Then, the failure detector 1001 outputs, to the CPU 1102, a signal indicating the movable imaging device in which the abnormal state has occurred. The CPU 1102 changes image taking ranges of all movable imaging devices that exist around the movable imaging device in which the abnormal state has occurred, or image taking ranges of movable imaging devices that satisfy specified conditions, so as to take an image of the movable imaging device in which the abnormal state has occurred. Then, the CPU 1102 transmits the changed image taking ranges through the information transmitter 117.

As a result of the above-described operation, if an abnormal state has occurred, it is possible to concentrate image taking ranges of movable imaging devices, which exist around the abnormal state, on an area in which the abnormal state has occurred, and to take picture images from all directions with no blind spot. Therefore, it is possible to sufficiently supply picture images so that the abnormal state is settled earlier. In addition, if this function is combined with the tracking function described in the above embodiment, it is possible to track an object that is moving away from the abnormal area, and to sufficiently supply picture images so that the object is captured.

### Seventh Embodiment

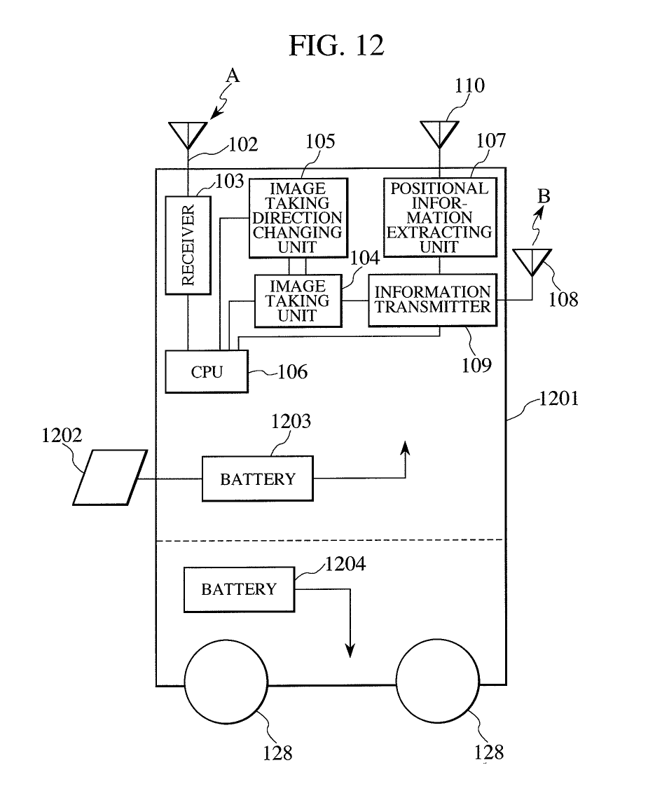

A seventh embodiment will be described with reference to FIG. 12. FIG. 12 is a diagram illustrating an example in which the power supply used for a portion which operates for moving is separated from the power supply used for the other portions in the movable imaging device 101 shown in FIG. 1. In FIG. 12, reference numeral 1201 denotes a movable imaging device according to this embodiment; reference numeral 1202 denotes a solar battery; and reference numerals 1203, 1204 denote batteries.

The operation will be described as below. The solar battery 1202 generates electricity by receiving a sunbeam. The generated electricity is charged into the battery 1203. Then, the charged electricity is used as the power supply for driving each of the elements 102 through 110. In addition, the battery 1204, which primarily exists, is used as the power supply for driving the portion that operates for moving.

As a result of the above-described operation, even if a vehicle is kept parked in the parking space for a while, continuous monitoring does not exert an influence upon moving because the power supply used for the portion which operates for moving is separated from the power supply used for the other portions. In addition, because the electricity used for the portions other than the portion which operates for moving is charged into the solar battery, the movable imaging device is capable of always operating as a monitoring camera.

### Eighth Embodiment

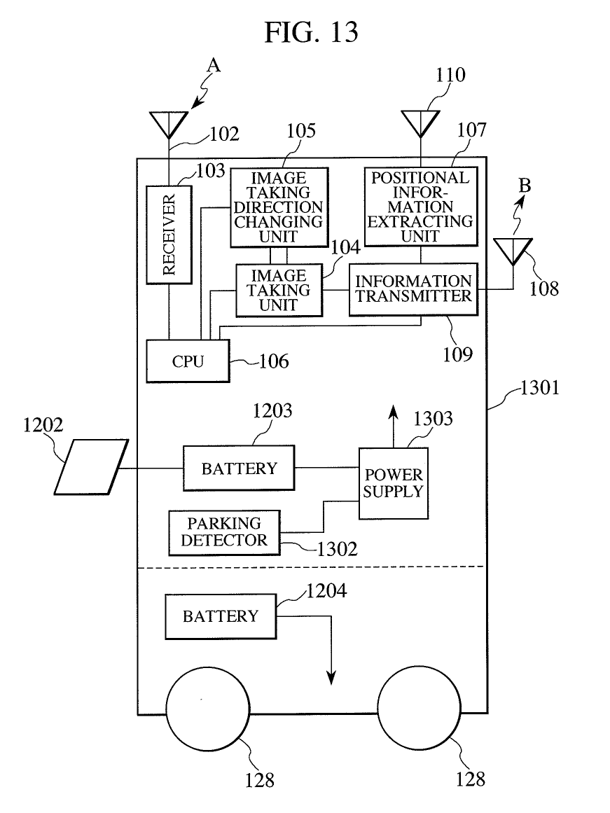

An eighth embodiment will be described with reference to FIG. 13. FIG. 13 is a diagram illustrating an example in which a unit which detects that a vehicle equipped with a movable imaging device is kept in a parked state is added to the embodiment shown in FIG. 12. In FIG. 13, reference numeral 1301 denotes a movable imaging device according to this embodiment; reference numeral 1302 denotes parking detector; and reference numeral 1303 denotes a power supply unit that stops the power supply by the output of the parking detector 1302. The connections will be described. The output of the battery 1203, and that of the parking detector 1302, are connected to the inputs of the power supply unit 1303 respectively. The output of the power supply unit 1303 is connected as the power supply used for the portions other than the portion that operates for moving. The other connections are the same as those shown in FIG. 12.

The operation will be described as below. On the basis of the speed of the movable imaging device 1301, or the revolution speed of the tires 128, or ON/OFF of the brake, if the parking detector 1302 judges that the movable imaging device 1301 is kept in a parked state, the parking detector 1302 outputs a signal indicating the parked state. On the receipt of the signal, the power supply unit 1303 supplies the power to the elements 102 through 110. In addition, if the output of the parking detector 1302 is a signal indicating a moving state, the power supply unit 1303 interrupts the power supply to the elements 102 through 110 on the receipt of the signal.

As a result of the above-described operation, only when the movable imaging device 1301 is kept in the parked state, the elements 102 through 110 can operate. In addition, the power supply unit used for the CPU 106 and the image taking unit 104 is also used for the portion that operates for moving. As a result, if the output of the parking detector 1302 is a signal indicating the moving state, it is possible to operate the movable imaging device as a usual in-vehicle camera. On the other hand, if the output of the parking detector 1302 is a signal indicating the parked state, it is possible to operate the movable imaging device as a monitoring network camera. Incidentally, although the in-vehicle camera is used as the movable imaging device here, it is not necessary to limit the movable imaging device to the in-vehicle camera. It is needless to say that, for example, a movable image taking robot may also be adopted in like manner.

For example, in a place that attracts many imaging devices, such as in-vehicle cameras, which are primarily used for different use, it is possible to complete the establishment of a monitoring network with the capital expenditure reduced. This produces the sufficient effect of an improvement in security, and of the early solution and prevention of an abnormal state. Therefore, it is possible to achieve the high availability.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A monitoring system comprising:
an imaging device including:
a picture image taking unit which takes a picture image;
a transmission unit which transmits the taken picture image to a remote location;
an image-taking-direction changing unit which changes an image taking direction in which the picture image taking unit takes a picture image;
an information receiving unit which receives information including operating conditions of the three units described above, said information being transmitted from the outside; and
an instruction unit which, on the basis of the information, issues an operation instruction to each of the units;
an operating-conditions transmission unit which transmits the operating conditions of each of the units from a remote location to the imaging device;
an image receiving unit which receives, at a remote location, an image that has been transmitted by the imaging device; and
an image recording/displaying unit which records or displays the received picture image;
wherein said imaging device includes an imaging device having a unit which enables movement to an arbitrary position; and
wherein said image recording/displaying unit includes:
a unit which performs image processing of picture images that are taken by one or more imaging devices, said one or more imaging devices being located around an object to be monitored;
a unit which detects, from the picture images that have been subjected to the image processing, the occurrence of an abnormal state of the object to be monitored; and
a unit which informs a specified security firm, device, person, or the like, of the occurrence of the abnormal state.

2. The monitoring system according to claim 1, wherein:
said operating-conditions transmission unit includes a unit which, in response to a position of each of the imaging devices that are located around the object to be monitored, changes an image taking range within which the each of the imaging devices takes a picture image.

3. The monitoring system according to claim 1, wherein:
said operating-conditions transmission unit includes:
a unit which detects the number of imaging devices that are located around the object to be monitored; and
a unit which, in response to the number of imaging devices that are located around the object to be monitored, changes an image taking range within which each of the imaging devices takes a picture image.

4. The monitoring system according to claim 1, wherein:
the operating-conditions transmission unit includes a unit which, in a place that attracts unspecified number of movable bodies, each of which is equipped with the imaging device, transmits information that is used to guide each of the movable bodies to a position at which an image of the whole object to be monitored is taken.

5. The monitoring system according to claim 1, wherein:
said operating-conditions transmission unit includes a unit which transmits information used for, in a place that attracts unspecified number of movable bodies, each of which is equipped with the imaging device, controlling image taking of an area around or inside another movable body that exists on the front or back side, or on the right or left side, of the movable body.

6. The monitoring system according to claim 1, wherein:
said operating-conditions transmission unit includes:
a tracking unit which tracks a movable body existing in a received picture image; and
a unit which, on the basis of the information received from the tracking means, changes an image taking range of each of the plurality of existing imaging devices so that an image of the movable body is taken.

7. The monitoring system according to claim 1, wherein:
said operating-conditions transmission unit includes a unit which, when the output of the unit which detects the occurrence of an abnormal state from the picture image is a signal that indicates an abnormal state, transmits an instruction to take an image of an area, in which the abnormal state has occurred, by use of the imaging devices existing around the area.

8. The monitoring system according to claim 1, wherein:
said imaging device includes a unit which provides the power supply to the image taking unit from a power supply unit that differs from a power supply unit for providing the power supply to the unit which enables movement to an arbitrary position.

9. The monitoring system according to claim 8, wherein the power supply of the image taking unit is a solar battery.

10. The monitoring system according to claim 1, said monitoring system further comprising:
a unit that operates only when the movable body equipped with the imaging device is kept in a parked state.

11. A monitoring system comprising a plurality of movable bodies, each of which includes an image taking unit, and a control device which communicates with the plurality of movable bodies,
said movable body including:
a first communication unit which communicates with the control device;
an image-taking-direction changing unit which changes an image taking direction of the image taking unit; and
a first control unit;
said control device including:
a second communication unit which communicates with the movable bodies;
a detection unit which detects the occurrence of an abnormal state by use of a picture image taken by the image taking unit;
an informing unit which informs a contact of the occurrence of the abnormal state; and
a second control unit;
wherein when the movable body enters an area around a target to be monitored, the first control unit included in the movable body controls the first communication unit so that the first communication unit communicates with the control device;
wherein in response to the communications with the movable body, the second control unit included in the control device determines an image taking range within which the movable body takes a picture image, and then controls the second communication unit so that the second communication unit communicates with the movable body to provide the movable body with information about the image taking range; and
wherein the first control unit included in the movable body uses the information about the image taking range to control the image-taking-direction changing unit so that the image taking unit takes a picture image over the image taking range.

12. A movable body included in a monitoring system, said monitoring system comprising:
a plurality of movable bodies, each of which includes image taking unit; and
a control device including:
a second communication unit which communicates with the plurality of movable bodies;
a detection unit which detects the occurrence of an abnormal state by use of a picture image taken by the image taking unit;
an informing unit which informs a contact of the occurrence of the abnormal state; and
a second control unit;
said movable body further including:
a first communication unit which communicates with the control device;
an image-taking-direction changing unit which changes an image taking direction of the image taking unit; and
a first control unit;
wherein when the movable body enters an area around a target to be monitored, the first control unit included in the movable body controls the first communication unit so that the first communication unit communicates with the control device;
wherein in response to the communications with the movable body, the second control unit included in the control device determines an image taking range within which the movable body takes a picture image, and then controls the second communication unit so that the second communication unit communicates with the movable body to provide the movable body with information about the image taking range; and
wherein the first control unit included in the movable body uses the information about the image taking range to control the image-taking-direction changing unit so that the image taking unit takes a picture image over the image taking range.

13. A control device included in a monitoring system, said monitoring system comprising:
a plurality of movable bodies, each of which includes:
an image taking unit;
a first communication unit which communicates with the control device;
an image-taking-direction changing unit which changes an image taking direction of the image taking unit; and
a first control unit; and
the control device for communicating with the plurality of movable bodies;
said control device including:
a second communication unit which communicates with the movable bodies;
a detection unit which detects the occurrence of an abnormal state by use of a picture image taken by the image taking unit;
an informing unit which informs a contact of the occurrence of the abnormal state; and
a second control unit;
wherein when the movable body enters an area around a target to be monitored, the first control unit included in the movable body controls the first communication unit so that the first communication unit communicates with the control device;
wherein in response to the communications with the movable body, the second control unit included in the control device determines an image taking range within which the movable body takes a picture image, and then controls the second communication unit so that the second communication unit communicates with the movable body to provide the movable body with information about the image taking range; and
wherein the first control unit included in the movable body uses the information about the image taking range to control the image-taking-direction changing unit so that the image taking unit takes a picture image over the image taking range.
